(19) United States
(12) Patent Application Publication
(10) Pub. No.: US 2005/0001822 A1
(43) Pub. Date: Jan. 6, 2005

(54) Resilient switch contact for a key switch device

(75) Inventor: Wei-Chen Chen, Taipei (TW)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: EMI STOP CORP.

(21) Appl. No.: 10/807,744

(22) Filed: Mar. 24, 2004

(30) Foreign Application Priority Data
Jun. 23, 2003 (TW) 092211417

(51) Int. Cl. H04K 1/00

(52) U.S. Cl. 345/173

(57) ABSTRACT

A resilient switch contact for a key switch device includes a unitary conductive body that has first and second mounting end portions disposed in a first plane and spaced apart from each other in a first direction, a central operating portion disposed in a second plane spaced apart from the first plane in a second direction transverse to the first direction and further disposed between the first and second mounting end portions, and first and second intermediate buffer portions, each of which interconnects a respective one of the first and second mounting end portions to a respective one of two ends of the central operating portion that are opposite to each other in the first direction.

### CROSS-REFERENCE TO RELATED APPLICATION

This application claims priority of Taiwanese Application No. 092211417, filed on Jun. 23, 2003.

### BACKGROUND OF THE INVENTION

1. Field of the Invention

The invention relates to a switch contact for a key switch device, more particularly to a unitary resilient switch contact for a key switch device.

2. Description of the Related Art

Referring to FIG. 1, a conventional key switch device 9 found in keypads of conventional portable electronic devices is shown to include a circuit board 8, a plastic biasing piece 91, a dielectric cover plate 92, and a key cap 93. The circuit board 8 is formed with a pair of electrical contacts 81 spaced apart from each other. The dielectric cover plate 92 is mounted on the circuit board 8, and cooperates with the circuit board 8 so as to confine a receiving space 921 that accommodates the electrical contacts 81. The plastic biasing piece 91 has first and second end portions 912 clamped between the circuit board 8 and the dielectric cover plate 92 and spaced apart from each other with the electrical contacts 81 disposed therebetween, and a curved intermediate biasing portion 913, which is inverted U-shaped, interconnecting the first and second mounting end portions 912, received and positioned in the receiving space 921, and spaced apart from the circuit board 8. A conductive portion 911 is mounted on the intermediate biasing portion 913, and is disposed above and is registered with the electrical contacts 81. The key cap 93 is mounted on the dielectric cover plate 92.

When the key cap 93 is pressed, the intermediate biasing portion 913 of the plastic biasing piece 91 is urged toward the circuit board 81 so as to drive movement of the conductive portion 911 from a normal position, where the conductive portion 911 is spaced apart from the electrical contacts 81, to a bridging position, where the conductive portion 911 interconnects electrically the electrical contacts 81. Thereafter, when the key cap 93 is released, the intermediate biasing portion 913 of the plastic biasing piece 91 provides a restoring force to move the conductive portion 911 from the bridging position back to the normal position.

Due to its complicated construction, the conventional key switch device 9 is usually assembled manually. As such, the conventional key switch device 9 incurs relatively high production costs.

### SUMMARY OF THE INVENTION

Therefore, the object of the present invention is to provide a unitary resilient switch contact for a key switch device that is relatively inexpensive to produce.

According to one aspect of the present invention, there is provided a resilient switch contact for a key switch device. The resilient switch contact comprises a unitary conductive body having:
first and second mounting end portions disposed in a first plane and spaced apart from each other in a first direction;
a central operating portion disposed in a second plane spaced apart from the first plane in a second direction transverse to the first direction, the central operating portion being further disposed between the first and second mounting end portions, the central operating portion having two ends opposite to each other in the first direction; and
first and second intermediate buffer portions, each of which interconnects a respective one of the first and second mounting end portions to a respective one of the ends of the central operating portion.

According to another aspect of the present invention, a key switch device comprises:
a circuit board formed with an electrical contact unit; and
a unitary conductive body having
   first and second mounting end portions spaced apart from each other in a first direction and mounted on the circuit board such that the electrical contact unit is disposed therebetween,
   a central operating portion disposed between the first and second mounting end portions and spaced apart from the electrical contact unit of the circuit board in a second direction transverse to the first direction the central operating portion having two ends opposite to each other in the first direction, and
   first and second intermediate buffer portions, each of which interconnects a respective one of the first and second mounting end portions to a respective one of the ends of the central operating portion.

The central operating portion is operable so as to move from a normal position, where the central operating portion is spaced apart from the electrical contact unit, to a pressed position, where the central operating portion and the first and second intermediate buffer portions deform and where the central operating portion contacts electrically the electrical contact unit.

Each of the first and second intermediate buffer portions provides a restoring force to move the central operating portion from the pressed position back to the normal position.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic sectional view of a conventional key switch device;

FIG. 2 is a fragmentary, partly exploded perspective view showing the first preferred embodiment of a key switch device according to the present invention;

FIG. 3 is a fragmentary schematic side view showing a unitary conductive body of the first preferred embodiment in a normal state;

FIG. 4 is a fragmentary schematic side view similar to FIG. 3, but showing the unitary conductive body in a pressed state;

FIG. 5 is a fragmentary, partly exploded perspective view showing the second preferred embodiment of a key switch device according to the present invention;

FIG. 6 is a perspective view showing a unitary conductive body of the third preferred embodiment of a key switch device according to the present invention;

FIG. 7 is a fragmentary schematic side view showing the third preferred embodiment when the unitary conductive body is in a pressed state;

FIG. 8 is a fragmentary schematic side view showing the fourth preferred embodiment of a key switch device according to the present invention; and

FIG. 9 is a fragmentary schematic side view showing the fourth preferred embodiment when a unitary conductive body thereof is in a pressed state.

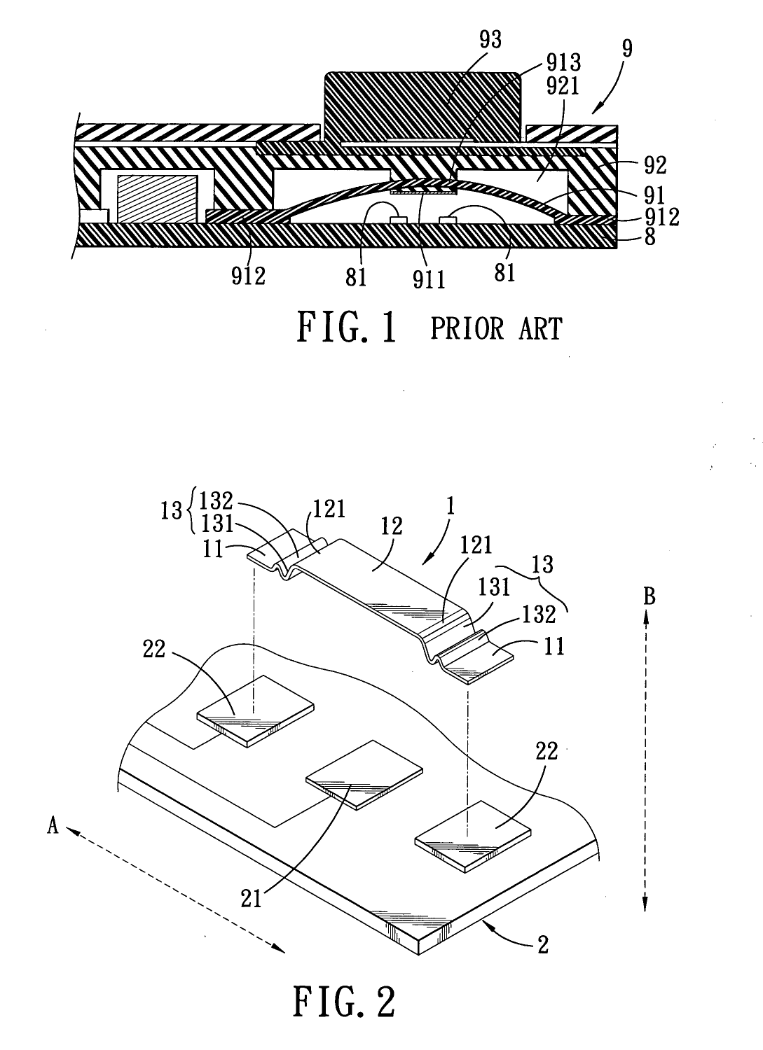

### DETAILED DESCRIPTION OF THE PREFERRED EMBODIMENTS

Before the present invention is described in greater detail, it should be noted that like elements are denoted by the same reference numerals throughout the disclosure.

Referring to FIGS. 2 to 4, the first preferred embodiment of a key switch device according to the present invention is shown to include a circuit board 2 and a unitary conductive body 1.

The circuit board 2 is formed with an electrical contact unit 21. In this embodiment, the circuit board 2 is further formed with a pair of solder pads 22 spaced apart from each other in a first direction (A).

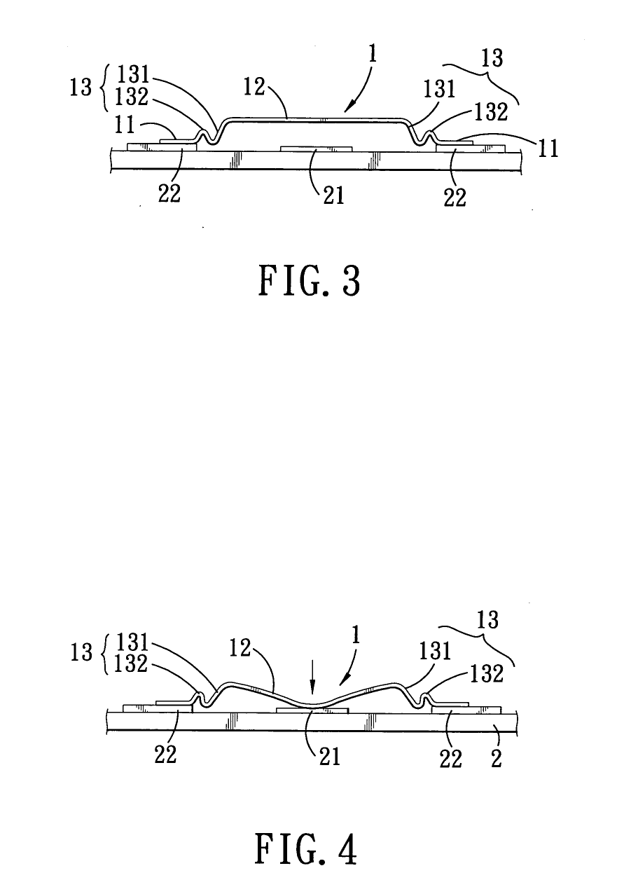

The unitary conductive body 1 has first and second mounting end portions 11, a central operating portion 12, and first and second intermediate buffer portions 13. The first and second mounting end portions 11 are spaced apart from each other in the first direction (A), and are mounted on the solder pads 22 on the circuit board 2 by surface mounting such that the electrical contact unit 21 is disposed therebetween, as best shown in FIG. 3. The central operating portion 12 is disposed between the first and second mounting end portions 11, and is spaced apart from the first and second mounting end portions 11 in a second direction (B) transverse to the first direction (A). The central operating portion 12 has two ends 121 opposite to each other in the first direction (A) Each of the first and second intermediate buffer portions 13 interconnects a respective one of the first and second mounting end portions 11 to a respective one of the ends 121 of the central operating portion 12. In this embodiment, each of the first and second intermediate buffer portions 13 includes a bend section 132 extending from the respective one of the first and second mounting end portions 11, and a linear extension section 131 extending from the bend section 132 to the respective one of the ends 121 of the central operating portion 12. Preferably, the bend section 132 is inverted U-shaped, as best shown in FIG. 3.

The central operating portion 12 is operable so as to move from a normal position, where the central operating portion 12 is spaced apart from the electrical contact unit 21, as shown in FIG. 3, to a pressed position, where the central operating portion 12 and the first and second intermediate buffer portions 13 deform and where the central operating portion 12 contacts electrically the electrical contact unit 21, as best shown in FIG. 4. In this embodiment, when the central operating portion 12 is in the pressed position, the central operating portion 12 connects electrically the electrical contact unit 21 to the solder pads 22.

Each of the first and second intermediate buffer portions 13 provides a restoring force to move the central operating portion 12 from the pressed position back to the normal position.

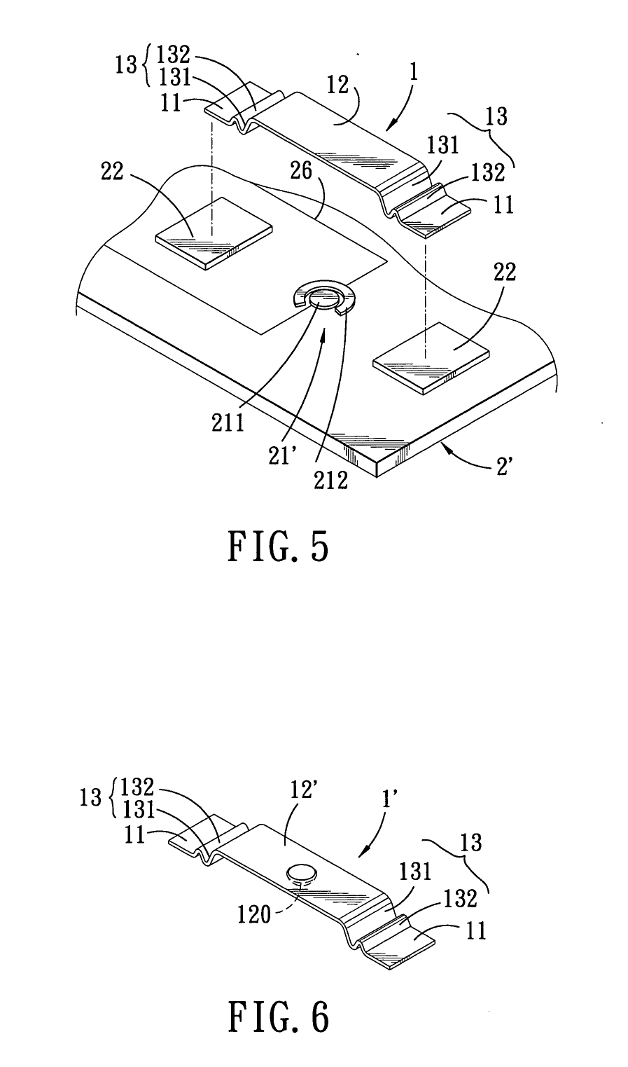

FIG. 5 illustrates the second preferred embodiment of a key switch device according to this invention, which is a modification of the first preferred embodiment. Unlike the previous embodiment, the electrical contact unit 21′ on the circuit board 2′ includes a pair of electrical contacts 211, 212 spaced apart from each other. The central operating portion 12 interconnects electrically the electrical contacts 211, 212 of the electrical contact unit 21′ when the central operating portion 12 is in the pressed position.

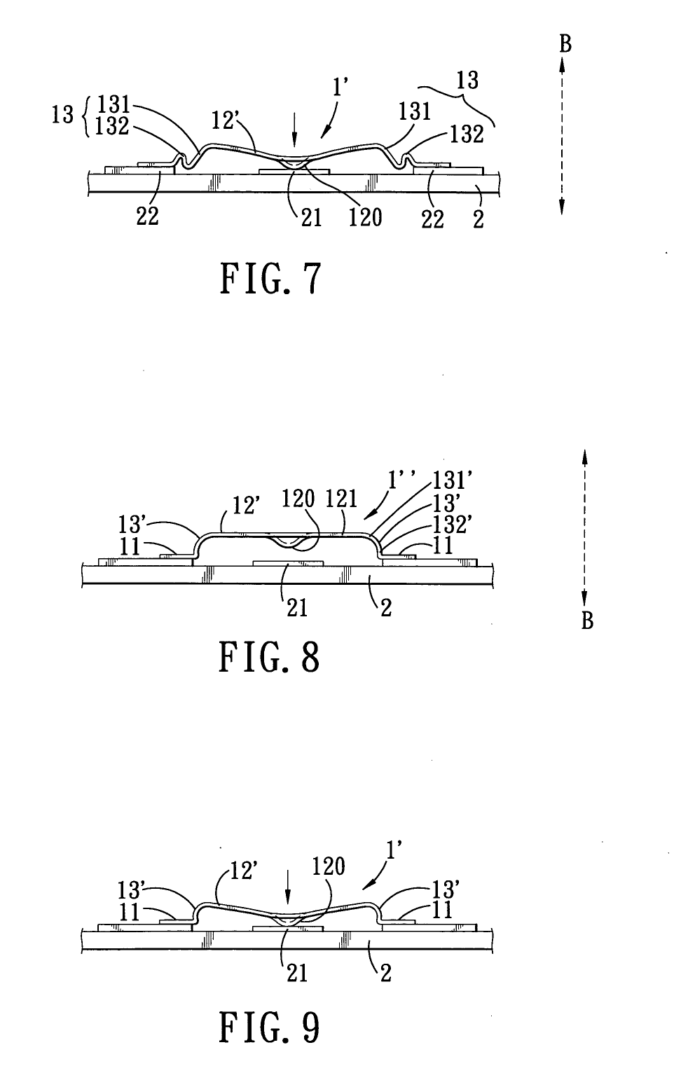

FIGS. 6 and 7 illustrate the third preferred embodiment of a key switch device according to this invention, which is a modification of the first preferred embodiment. In this embodiment, the central operating portion 12′ of the unitary conductive body 1′ is formed with a projection 120 that protrudes in the second direction (B) toward the circuit board 2 and that contacts electrically the electrical contact unit 21 when the central operating portion 12′ is in the pressed position.

FIGS. 8 and 9 illustrate the fourth preferred embodiment of a key switch device according to this invention, which is a modification of the first preferred embodiment. In this embodiment, each of the first and second intermediate buffer portions 13′ of the unitary conductive body 1″ includes a first curved section 132′ extending from the respective one of the first and second mounting end portions 11 in the second direction (B) toward the other one of the first and second intermediate buffer portions 13′, and a second curved section 131′ extending from the first curved section 132′ in the second direction (B) toward the respective one of the ends 121 of the central operating portion 12′.

To sum up, since the unitary conductive body 1, 1′ 1″, which serves as a switch contact, is formed by punching, the drawbacks attributed to the complicated construction of the aforementioned conventional key switch device can be overcome. Furthermore, since the first and second mounting end portions 11 can be mounted accurately and automatically on the circuit board 2, 2′ by surface mounting, assembly efficiency is enhanced. Moreover, the key switch device of this invention has a smaller profile as compared to the prior art.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A resilient switch contact comprising a unitary conductive body having:
first and second mounting end portions disposed in a first plane and spaced apart from each other in a first direction;
a central operating portion disposed in a second plane spaced apart from the first plane in a second direction transverse to the first direction, said central operating portion being further disposed between said first and second mounting end portions, said central operating portion having two ends opposite to each other in the first direction; and
first and second intermediate buffer portions, each of which interconnects a respective one of said first and second mounting end portions to a respective one of said ends of said central operating portion.

2. The resilient switch contact as claimed in claim 1, wherein each of said first and second intermediate buffer portions includes a bend section extending from the respective one of said first and second mounting end portions, and a linear extension section extending from said bend section to the respective one of said ends of said central operating portion.

3. The resilient switch contact as claimed in claim 2, wherein said bend section is inverted U-shaped.

4. The resilient switch contact as claimed in claim 1, wherein each of said first and second intermediate buffer portions includes a first curved section extending from the respective one of said first and second mounting end portions in the second direction toward the other one of said first and second intermediate buffer portions, and a second curved section extending from said first curved section in the second direction toward the respective one of said ends of said central operating portion.

5. The resilient switch contact as claimed in claim 1, wherein said central operating portion is formed with a projection that protrudes in the second direction toward the first plane.

6. A key switch device comprising:
a circuit board formed with an electrical contact unit; and
a unitary conductive body having
first and second mounting end portions spaced apart from each other in a first direction and mounted on said circuit board such that said electrical contact unit is disposed therebetween,
a central operating portion disposed between said first and second mounting end portions and spaced apart from said electrical contact unit of said circuit board in a second direction transverse to the first direction, said central operating portion having two ends opposite to each other in the first direction, and
first and second intermediate buffer portions, each of which interconnects a respective one of said first and second mounting end portions to a respective one of said ends of said central operating portion,
said central operating portion being operable so as to move from a normal position, where said central operating portion is spaced apart from said electrical contact unit, to a pressed position, where said central operating portion and said first and second intermediate buffer portions deform and where said central operating portion contacts electrically said electrical contact unit,
each of said first and second intermediate buffer portions providing a restoring force to move said central operating portion from the pressed position back to the normal position.

7. The key switch device as claimed in claim 6, wherein each of said first and second intermediate buffer portions includes a bend section extending from the respective one of said first and second mounting end portions, and a linear extension section extending from said bend section to the respective one of said ends of said central operating portion.

8. The key switch device as claimed in claim 7, wherein said bend section is inverted U-shaped.

9. The key switch device as claimed in claim 6, wherein each of said first and second intermediate buffer portions includes a first curved section extending from the respective one of said first and second mounting end portions in the second direction toward the other one of said first and second intermediate buffer portions, and a second curved section extending from said first curved section in the second direction toward the respective one of said ends of said central operating portion.

10. The key switch device as claimed in claim 6, wherein said central operating portion is formed with a projection that protrudes in the second direction toward said circuit board and that contacts electrically said electrical contact unit when said central operating portion is in the pressed position.

11. The key switch device as claimed in claim 6, wherein said circuit board is further formed with a pair of solder pads for mounting said first and second mounting end portions of said conductive body respectively thereon, said central operating portion connecting electrically said electrical contact unit to said solder pads when said central operating portion is in the pressed position.

12. The key switch device as claimed in claim 6, wherein said electrical contact unit includes a pair of electrical contacts spaced apart from each other, said central operating portion interconnecting electrically said electrical contacts of said electrical contact unit when said central operating portion is in the pressed position.
